(19) United States
(12) Patent Application Publication
(10) Pub. No.: US 2015/0003500 A1
(43) Pub. Date: Jan. 1, 2015

(54) Baseband Cancellation of Direct Sequence Spread Spectrum Platform Radio Interference

(71) Applicant: Dawson W. Kesling, Davis, CA (US)

(72) Inventor: Dawson W. Kesling, Davis, CA (US)

(21) Appl. No.: 13/928,468

(22) Filed: Jun. 27, 2013

(51) Int. Cl. H04B 1/7097

(52) U.S. Cl. CPC H04B 1/7097
USPC 375/148

(57) ABSTRACT

Briefly, in accordance with one or more embodiments, a platform may comprise a receiver to receive a signal that includes an error in the received signal due to a noise signal generated in the platform, and a processor configured to calculate a noise vector from a source of the noise signal. The noise vector may be de-spread. The receiver may include digital signal processing configured to estimate an error vector based at least in part on the noise vector and to subtract the estimated error vector from the received signal to cancel the noise signal from the received signal. The noise cancelled from the received signal may include platform noise generated by a bus, a memory circuit, a clock, a power supply, a circuit ground or integrated circuit substrate, or input/output circuit of the platform.

### BACKGROUND

This relates generally to direct sequence spread spectrum (DSSS) radio systems.

Interference with platform wireless operation caused by noise coming from system buses and clocks internal to a device, referred to as platform noise, is a growing concern. The impact of such platform noise is becoming more severe in smaller, more radio-rich platforms and frequently forces higher costs, delayed product launches due to redesign and retest cycles, and post launch end user complaints.

Shielding is the predominant industry solution but is undesirable due to materials and tooling costs as well as impacts on form factor flexibility which for example impacts cooling, weight, and product thickness.

### BRIEF DESCRIPTION OF THE DRAWINGS

Claimed subject matter is particularly pointed out and distinctly claimed in the concluding portion of the specification. However, such subject matter may be understood by reference to the following detailed description when read with the accompanying drawings in which:

FIGS. 1A and 1B are example platforms capable of mitigating radio interference from one or more noise sources in accordance with one or more embodiments;

FIG. 2 is a direct-sequence spread spectrum graph in accordance with one or more embodiments;

FIG. 3 is a diagram of the various components in a DSSS receiver in accordance with one or more embodiments;

FIG. 4 is a diagram showing detail of a portion of the cancellation system in accordance with one or more embodiments;

FIG. 5 is a block diagram of an external radio transmitter and portions of a platform capable of cancelling platform radio interference in accordance with one or more embodiments;

FIGS. 6A and 6B are example simulation results of the cancellation of radio interference in accordance with one or more embodiments;

FIG. 7 is a flow diagram of a method to cancel platform radio interference in accordance with one or more embodiments;

FIG. 8 is a block diagram of an information handling system capable of baseband cancellation of platform radio interference in accordance with one or more embodiments; and

FIG. 9 is an isometric view of an information handling system of FIG. 8 that optionally may include a touch screen in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In accordance with some embodiments, a direct sequence spread spectrum receiver receives a signal including an undesired platform generated noise signal. A noise vector is generated from the noise source, filtered, and subtracted from the received signal.

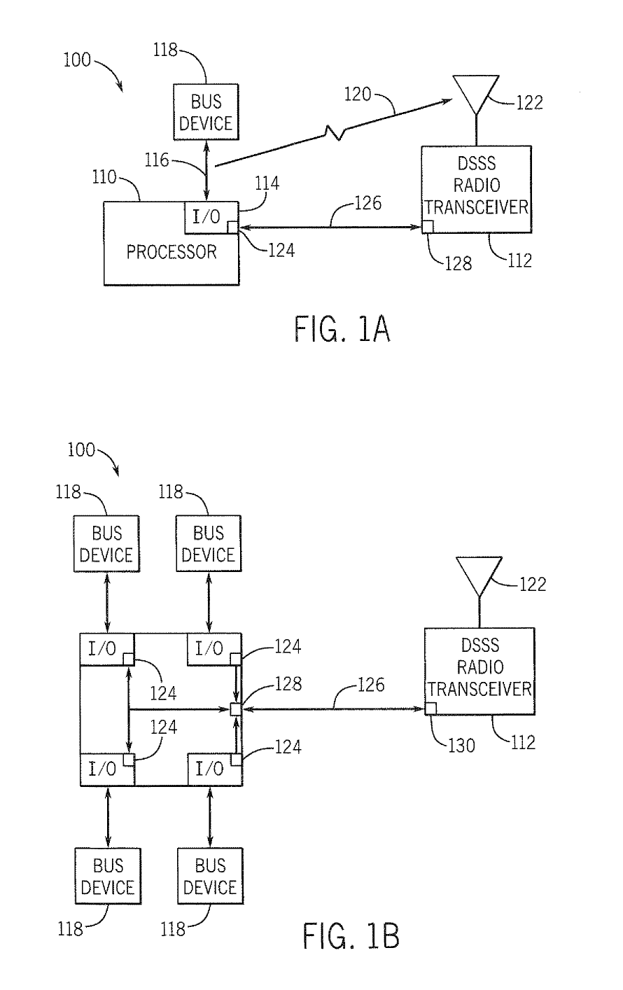

As shown in FIG. 1A, a platform 100 may include a processor 110 coupled with a direct sequence spread spectrum (DSSS) radio transceiver 112 wherein the processor 110 may include or couple to an input/output (I/O) controller 114 or other data circuit. The I/O controller 114 may implement a bus 116 to couple with one or more bus devices 118. The bus 116 may comprise one or more data and/or clock lines or traces and power planes to communicate with bus device 118 and to optionally deliver power to the bus device 118. Such signal, clock or power lines of bus 116 may radiate noise 120 that may be picked up at the antenna 122 of the radio transceiver 112 that may inadvertently be introduced into the radio-frequency (RF) signals received by the radio transceiver 112. The noise may also be coupled directly to the radio by the direct connection of the power delivery network. The signals radiated from the bus device 118 may generate interference in the RF spectrum at or near the frequency of operation of the radio transceiver 112, either at the specific operational frequency or via generation of harmonics by the bus or clock signals that fall in the same RF spectrum as the RF signals utilized by the radio transceiver 112. In one or more embodiments, such noise 120 may be referred to generally as platform interference or platform noise since the interference is often generated within a single system wherein one subsystem may generate interference with one or more other subsystems in the device. In general, the platform noise may be generated by any data circuit of the platform and/or any trace or line that may carry such signal either intentionally or inadvertently including but not limited to a bus, a memory device, a clock, a power supply, or input/output circuit.

In accordance with one or more embodiments, the I/O controller 114 or similar bus or clock device may include a noise vector generator 124 that calculates the noise vectors representative of the noise 120 radiated by the bus 116 to the radio transceiver 112. The noise vectors calculated by the noise vector generator 124 may be transmitted to the radio transceiver 112 via a link which may comprise a low speed data link 126 in one or more embodiments. Such a low speed data link 126 may transmit data on the order of tens of megabytes per second or so, and may be implemented using existing interfaces such as a peripheral component interconnect express (PCIe) interface, a universal serial bus (USB) and/or USB high speed inter-chip (HSIC) interface, or the M-PHY specification set forth by the Mobile Industry Processor Interface (MIPI) Alliance, although the scope of the claimed subject matter is not limited in this respect.

The radio transceiver 112 may include a noise vector scaling and synchronization block 128 that receives noise vectors over link 126 for synchronization and scaling. In one or more embodiments, the noise vector scaling and synchronization block 128 may be realized by a digital signal processor of the radio transceiver 112, although the scope of the claimed subject matter is not limited in this respect. The synchronized and scaled noise vectors represent estimated error vectors, EV′, and may be cancelled from received radio signals at radio transceiver 112 so that the received radio signals may effectively have the interference due to the noise eliminated from the radio signals.

It should be noted that the term “cancel” as used herein may refer to cancelling all, nearly all, or at least a portion of the noise from a signal such that the data encoded in the signal may be decoded, determined, or recovered with a reduced error rate in comparison with the error rate that would otherwise occur without cancellation of the noise. In general, the term cancel may mean that noise is removed, reduced or mitigated, and may not necessarily mean that all of the noise is completely removed from a signal. In some embodiments, cancellation of noise may refer to the concept of noise cancellation as known to those of skill in the art. However, these are merely one of several possible meanings of the term cancel or cancellation, and the scope of the claimed subject matter is not limited in these respects. It should be noted that the term “scaling” as used herein may refer to multiplicative scaling by real or complex quantities, or filtering in a more general sense.

FIG. 1B illustrates the cancellation of such radio interference due to platform noise 120 generated by multiple I/O devices 114 and/or multiple buses 116 wherein the I/O devices 114 contain a respective noise vector generator 124. In such an embodiment, the processor 110 may include the noise vector synchronization and scaling block 128 which is coupled via link 126 to a noise vector control block 130 in the radio transceiver 112. The platforms 100 of FIG. 1A and FIG. 1B are capable of cancelling noise radiated from bus and clock board or package traces and power planes of the platform 100 and further are capable of cancelling conducted noise. In general, the platforms 100 of FIG. 1A and FIG. 1B cancel radio interference noise 120 by generating a measure of the bus and/or clock noise at the noise source, providing this information to the radio transceiver 112 over the link 126, and cancelling the platform interference in the baseband digital signal processor (DSP) of the radio transceiver 112. In one or more embodiments, such platform interference cancellation may be a fully digital solution.

Noise cancellation, in accordance with one or more embodiments, may be described herein in terms of direct sequence spread spectrum (DSSS), which is one particular technology used in modern digital radios such as a wireless local area network (WLAN) or a Wi-Fi network as set forth by the Wi-Fi alliance in accordance with an Institute of Electrical and Electronics Engineers (IEEE) standard including but not limited to some releases of IEEE 802.11, a mobile cellular network such as a 3G network employing code division multiple access technology as set forth by the Universal Mobile Telecommunications System (UMTS), a satellite based geo-positioning system, or a personal area network including but not limited to a ZigBee network as set forth by IEEE standard 802.14.

Direct sequence spread spectrum (DSSS) techniques rely on the use of pseudo-noise carriers, also called spreading codes, spreading sequences, code sequences and chip sequences, and a transmission bandwidth which is much wider than the minimum required to transmit the information. The transmitter spreads the information by modulating the information with a pseudo-noise spreading sequence. At the receiver, the information is de-spread to recover the base information. This de-spreading is accomplished by correlating the received, spread-modulated, signal with the spreading sequence used for the transmission.

The modulating signal, such as a pseudo-random spreading code signal, possesses a chip rate (analogous to carrier frequency) which is much larger than the data rate of the information signal. This characteristic is required for efficient spreading. Each state of the pseudo-random spreading sequence is referred to as a chip. The spreading sequence (chip sequence) directly modulates each bit of the information signal, hence the name direct spread. Pseudo-randomness of the spreading signal is required in order to recover the original information signal. Since the spreading sequence is deterministic, it can be exactly duplicated at the receiver in order to extract the information signal.

The spreading operation causes the signal power to be distributed across the spread bandwidth. Any undesired signal picked up during transmission is spread by the receiver in the same way that the transmitter spread the desired signal originally. In other words, the receiver spreads undesired signals picked up during transmission, while simultaneously de-spreading, or demodulating, the desired information signal. Processing gain is the term used to express this interference suppression in the overall transmit/receive operation. When viewed as a transmit/receive operation, the desired signal is spread-modulated twice, giving back the original signal, while in-band interference is spread-modulated once, and thereby depleted across the full spread bandwidth.

CDMA direct spread is an adaptation of conventional direct spread which accommodates multiple simultaneous access through the use of mutually orthogonal spreading codes. Mutually orthogonal means the cross correlation of any spreading code in the set is small (ideally zero). In an ideally orthogonal system, orthogonality not only means that there is no mixing of signals, but it also means that there is no interference between signals.

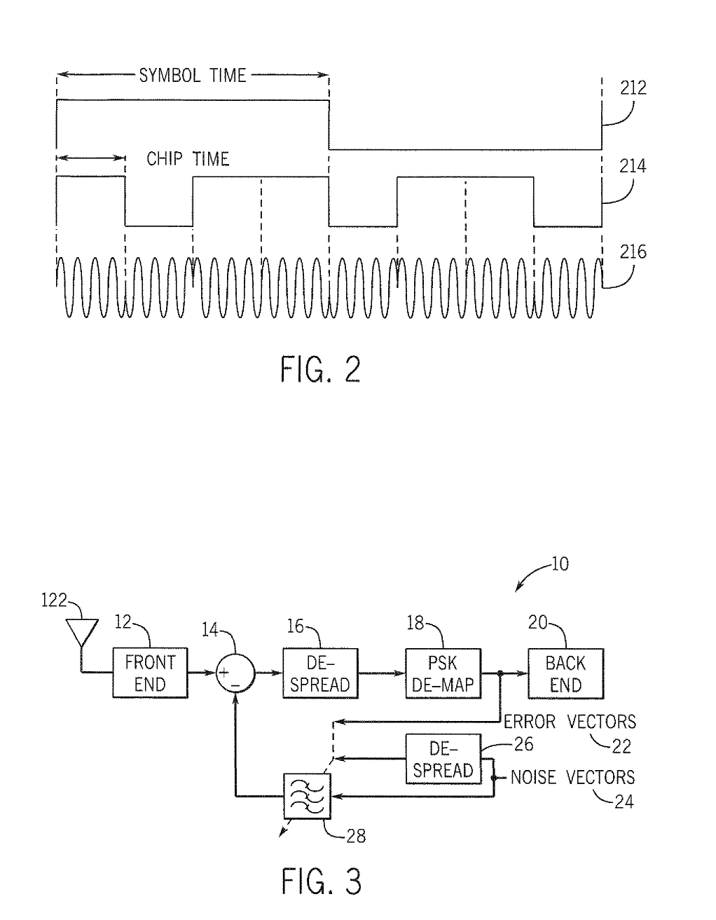

A direct-sequence spread spectrum multiplexing graph, in accordance with one or more embodiments, shown in FIG. 2, includes the radio frequency (RF) signal 216 of a single DSSS carrier under a DSSS code signal 214 generated by spreading a radio data signal 212.

A DSSS receiver, shown in FIG. 3, includes an antenna 122, coupled to a front end 12. The front end 12 may include an amplifier coupled to a band pass filter in accordance with some embodiments. The front end 12 is coupled to a subtractor 14, that subtracts a feedback sequence from the output of the front end 12. A de-spread 16 de-spreads the signal in accordance with conventional DSSS technology to recover the original symbols. The de-spread 16 may be coupled to a phase shift key (PSK) or other constellation de-mapping function 18. The output of the de-mapping 18 includes the error vectors 22 that are passed to an adaptive filter 28. The noise vectors 24 are de-spread by de-spread 26 (which may be identical to de-spread 16 in one embodiment) and passed to the adaptive filter 28. The noise vector 24 is also passed to the adaptive filter 28 without de-spreading. The output of the adaptive filter is then subtracted from the signal recovered by the front end 12.

The output of the de-mapping 18 also goes to a conventional back end 20, which may, for example, include further decoding and error checking.

The coefficient or tap weight update section of the adaptive filter may be driven by a combination of the error signal, such as the error vectors as illustrated, and the signal to be filtered, including the noise vectors as illustrated in this case. The noise vectors are filtered and subtracted from the received signal at the chip rate, before de-spreading, in order to maintain correlation of the portion of the chip error due to bus noise. But since the only error signal available for driving the adaptive filter has been de-spread, the noise vector input to the coefficient update section is also de-spread with the same sequence.

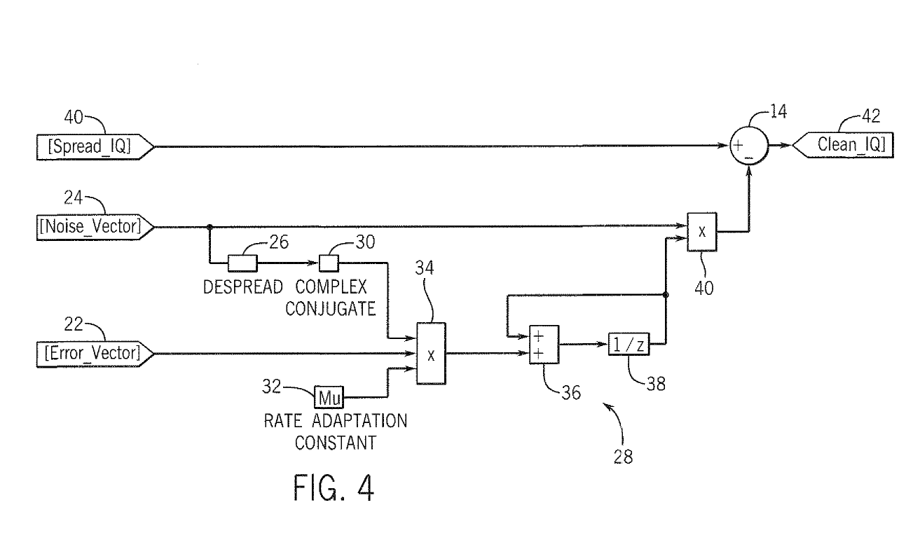

A more detailed block diagram of an adaptive filter with coefficient update de-spreading is shown in FIG. 4 for the example of a single filter tap. Here the spread in-phase (I) and quadrature (Q) components 40 from the front end 12 are passed to the subtractor 14 to produce clean I-Q signals 42. The noise vector 24 is passed to the multiplier 40. It is also de-spread by de-spread 26 and passed through conventional complex conjugate 30. Then it is passed to a multiplier 34 and then to an adder 36. Next, it is passed through a 1/z 38, before being provided to the multiplier 40. Thus, the multiplier 40 receives both the de-spread noise vector 24 and the noise vector 24 without de-spreading. However, other adaptive filters can also be used.

The error vector 22 goes to the multiplier 34, as does a rate adaptation constant 32. The output from the multiplier 34 is added to the feedback at 36 and then passed to the 1/z 38. The 1/z unit is a time delay or a radio time symbol delay, such as a register or latch delay of one clock symbol at the radio symbol rate.

In some embodiments, the noise vector is de-spread going into the feedback loop, but the noise vector is also not de-spread going on another path into the multiplier 40. Thus, the noise vectors at the chip rate are provided in a DSSS radio receiver.

Direct sequence spread spectrum is a spread spectrum modulation technique where a sine wave carrier is pseudo randomly modulated with a continuous string of pseudo random spreading code signals called chips, each of which has a much shorter duration than an information symbol. The idea is to cancel noise at the spread chip rate, not the de-spread symbol rate, in order to remove all, or at least more, of the noise. The noise vectors are calculated at the chip or spread rate.

DSSS divides the information signal symbol time into shorter times and randomly inverts the signals at these short time intervals using a spreading or chip code. Several radio users can be on the same frequency, but each has a different code. Then a receiver can recover a desired user's signal by de-spreading with that user's code. Other users' signals get averaged away by de-spreading at the receiver. The noise vectors are generated at the chip rate and subtracted from the incoming signal at the chip rate in order to remove noise over the full spread signal bandwidth. The adaptive filter scales the noise vectors so they closely match the error vectors. After subtraction, ideally the error vectors become very small or approach zero.

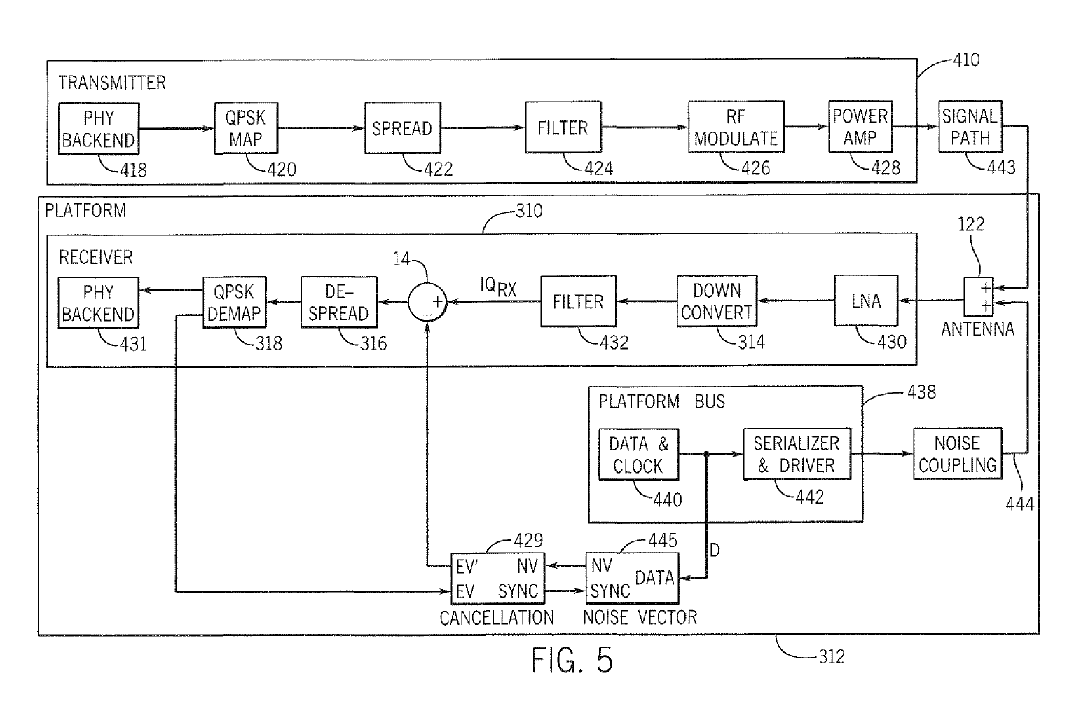

Referring now to FIG. 5, a DSSS transmitter 410 sends a signal on a signal path 443 to a DSSS receiver 310. An IO bus in the same physical system as the receiver may introduce radio-frequency interference (RFI) in accordance with one or more embodiments. The transmitter 410 may comprise a PHY back end 418, QPSK modulator 420, direct sequence spreader 422, filter 424, which may comprise a square root filter, RF modulator 426, and power amplifier 428. Platform 100 may comprise a DSSS receiver 310, data bus 438, a noise vector generator (NV) 445 including data and sync inputs, and a cancellation block 429. Platform radio frequency interference (RFI) is coupled into the receiver 310 from a nearby data bus 438, comprising data and clock block 440 and serializer/driver block 442 coupled to antenna 122 via noise path 444. The receiver 310 may comprise a low noise amplifier 430, down converter 314, receiver filter 432, de-spreader 316, QPSK demodulator 318, and PHY back end logic 431.

The difference between the received I-Q vectors and the corresponding I-Q vectors sent by the transmitter 410 are error vectors (EV) introduced by the radio-frequency interference (RFI). It should be noted that in general, any noise or interference generate in or by the platform 100 may be referred to as platform interference, and in general such interference may interfere with one or more radios of the platform 100 at radio frequencies, so such platform interference may also be referred to as radio frequency interference, noise, platform noise, or platform radio frequency interference. However, the scope of the claimed subject matter is not limited in this respect. Such error vectors may prevent the demodulator 318 from recovering the intended data reliably. It is noted that other noise mechanisms normally present in wireless systems are neglected for clarity.

In platform 100, receiver (RX) 310 represents the first stages of the wireless receiver of platform 100. Although platform 100 may include a transmitter as a component of radio transceiver 112, typically the signals received by the receiver 310 of platform 100 are transmitted from a remote device wherein the transmitter 410 is part of the remote device and not part of platform 100. Bus noise from bus (BUS or I/O) 438 introduces an error vector, EV, into the received baseband vector IQ_{RX}. Noise vectors, NV, are calculated from bus data, D, and scaled for the noise coupling path and the front end of receiver 310 to find estimated error vectors, EV′. The estimated error vectors EV′ are finally subtracted from the baseband I-Q vectors to get enhanced baseband vectors for de-spreading. The effect of the noise on the transmitted vector at the received baseband vector is the error vector, and the effect of subtracting the estimated error vector from the received baseband vector is to result in the enhanced baseband vector.

The effects of the noise interference 120 can be removed if the error vectors can be determined and subtracted from the received I-Q vectors prior to de-spreading 316. Analysis of the received signal chain shows that the error vector of each carrier in each symbol period is proportional to the value at the carrier frequency of the complex spectrum of the bus noise at bus 438 when the spectrum is taken over the symbol period. The complex constant of proportionality depends on the noise coupling and radio front end gain and phase response. In one or more embodiments, the bus or clock noise vectors, NV, are calculated at each symbol time based on the bus or clock signal, D, scaled for the gain and phase of the noise coupling path and receiver front end, and then the estimated error vectors, EV′, are subtracted from the received I-Q vectors, IQ_{RX}.

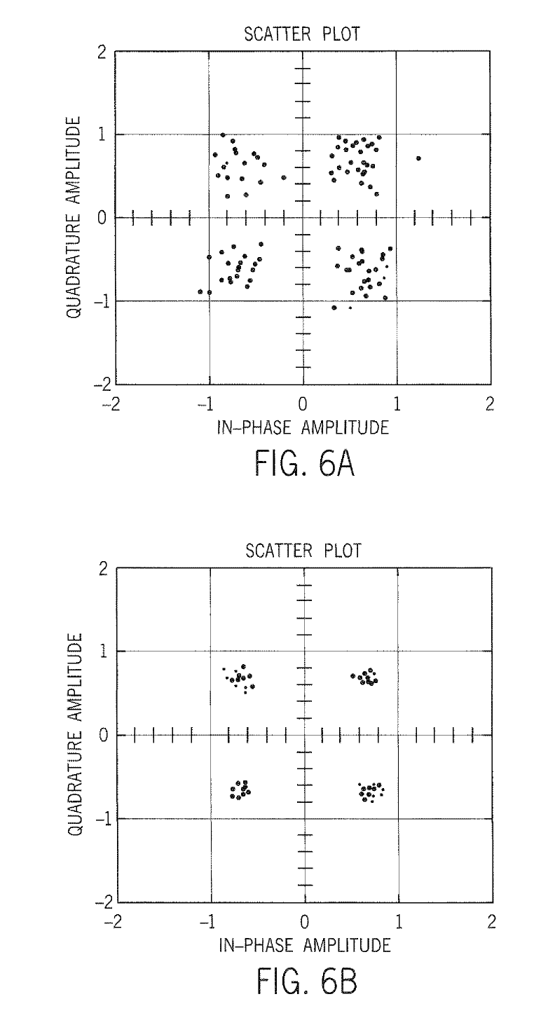

FIGS. 6A and 6B represent simulation results for global positioning system (GPS) reception in the presence of noise from a 1067 MT/s double data rate (DDR) bus with cancellation of radio interference, in accordance with one or more embodiments. FIG. 6A shows the received constellation with radio-frequency interference (RFI) noise showing a symbol error rate of 7.5% per the simulation. FIG. 6B shows the received constellation with cancellation of the RFI via subtraction of the estimated error vectors EV′ from the received baseband signal wherein the symbol error rate is effectively reduced to about 0%.

In one or more embodiments, the manner in which spectral noise vectors are calculated will result in cancellation of the RFI noise. In one embodiment, a discrete Fourier transform (DFT) may be applied to the bus data. The DFT may involve a high sampling rate to achieve the desired accuracy. In a particular embodiment, a simpler discrete time Fourier transform (DTFT) approach involves calculating the noise vectors at the bus transfer or baud rate. An example approach for phasor-based line coding applications is described in International Application No. PCT/US2011/054498 filed Oct. 1, 2011 by the assignee of the present application. Said Application No. PCT/US2011/054498 is hereby incorporated herein by reference in its entirety. In such an approach, the noise vectors may be calculated by noise vector generator 124 using the following simplified formula:

$$NV = {\sum }_{b = 1}^{n} {x}_{b} {e}^{- i 2 π {bf}_{r} / {f}_{BR}}$$

where fᵣ is the DSSS carrier frequency, x_{b} is the bus data at bit time b and f_{BR} is the bus baud rate, the bit transfer rate of a single bus lane. The sum is taken over the radio symbol period. Note that x_{b} does not need to be binary. Such an approach may be applied to multiple lanes of bus data simultaneously by adding the binary values of each lane together to form an equivalent multi-valued data signal. In addition, f_{BR} may be a fixed parameter or it may be varied in synchronization with any spread spectrum clocking (SSC) utilized in the noise source. Such an approach may be easily extended for buses having transmit pre-equalization by adding another term in the summation.

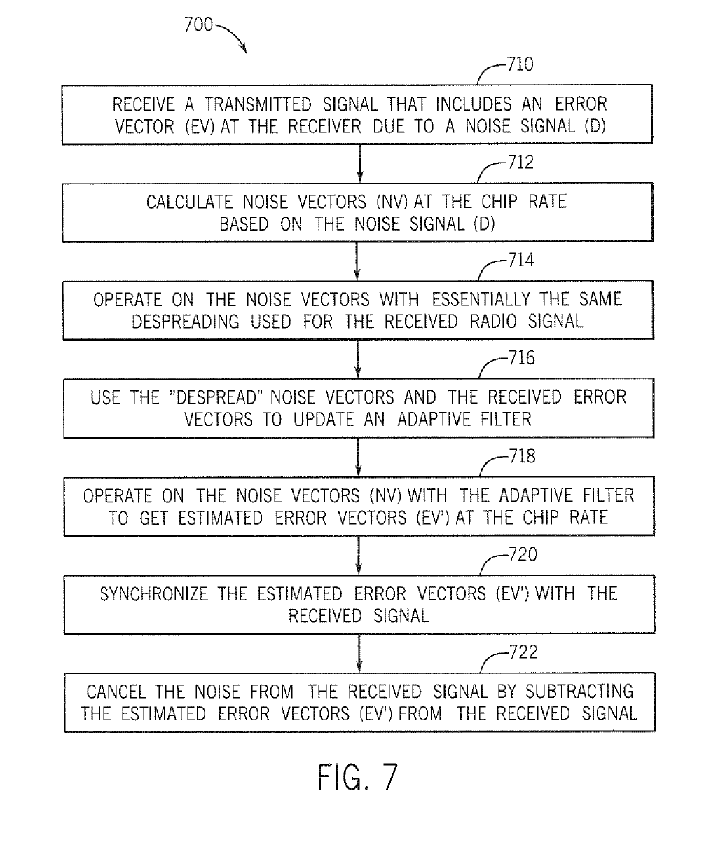

Referring now to FIG. 7, a flow diagram of a method to cancel platform radio interference in accordance with one or more embodiments will be discussed. Method 700 may include more or fewer blocks than shown in FIG. 7, and/or the blocks maybe arranged in various other orders than shown, and the scope of the claimed subject matter is not limited in this respect. A transmitted signal may be received at block 710 wherein the signal includes an error vector introduced at the receiver due to some noise signal generated by or in the platform 100. Noise vectors representing the noise signal may be calculated at block 712 at the chip rate based, at least in part, on the noise signal. The noise vectors are operated on with essentially the same de-spreading used for the received radio signal (block 714). The de-spread noise vectors are used with the received error vector to update an adaptive filter (block 716). The noise vectors are operated on with the adaptive filter to get estimated error vectors at the chip rate (block 718). The estimated error vectors are synchronized with the received signal symbols at block 720, and the noise is cancelled from the received signal by subtracting the estimated error vectors from the received signal at block 722. In one embodiment, synchronization is done automatically to minimize the resulting error vector.

In accordance with some embodiments, the flow diagram represented in FIG. 7 may be implemented in software, firmware and/or hardware. In software and firmware embodiments, it may be implemented by computer readable instructions stored in one or more non-transitory computer readable media, such as magnetic, optical, or semiconductor storages.

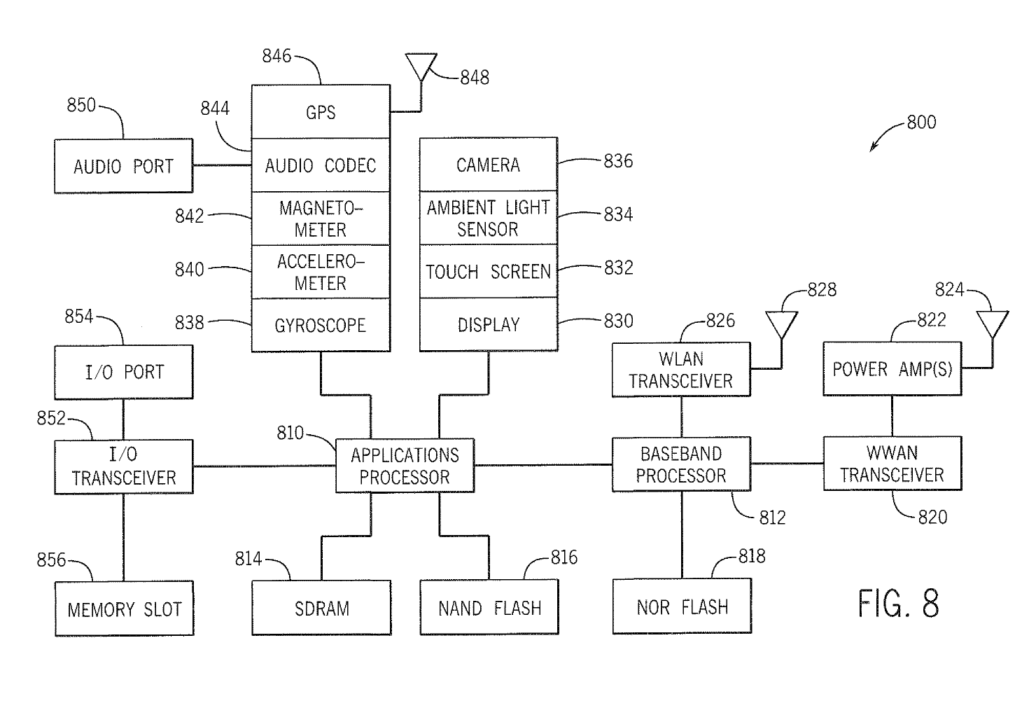

Referring now to FIG. 8, a block diagram of an information handling system capable of baseband cancellation of platform radio interference in accordance with one or more embodiments will be discussed. Information handling system 800 of FIG. 8 may tangibly embody one or more of any of the network elements or devices of platform 100 as shown in and described with respect to FIG. 1, with greater or fewer components depending on the hardware specifications of the particular device or network element. Although information handling system 800 represents one example of several types of computing platforms, information handling system 800 may include more or fewer elements and/or different arrangements of elements than shown in FIG. 8, and the scope of the claimed subject matter is not limited in these respects.

In one or more embodiments, information handling system 800 may include an applications processor 810 and a baseband processor 812. Applications processor 810 may be utilized as a general purpose processor to run applications and the various subsystems for information handling system 800. Applications processor 810 may include a single core or alternatively may include multiple processing cores wherein one or more of the cores may comprise a digital signal processor or digital signal processing core. Furthermore, applications processor 810 may include a graphics processor or coprocessor disposed on the same chip, or alternatively a graphics processor coupled to applications processor 810 may comprise a separate, discrete graphics chip. Applications processor 810 may include on board memory such as cache memory, and further may be coupled to external memory devices such as synchronous dynamic random access memory (SDRAM) 814 for storing and/or executing applications during operation, and NAND flash 816 for storing applications and/or data even when information handling system 800 is powered off. In general, any of the memory devices of information handling system 800 may comprise an article of manufacture having instructions stored thereon that cause a processor of the information handling system 800 to execute the instructions to implement any method or process wholly or in part as described herein. Baseband processor 812 may control the broadband radio functions for information handling system 800. Baseband processor 812 may store code for controlling such broadband radio functions in a NOR flash 818. In one embodiment, computer executed instructions to implement the sequence of FIG. 7 may be stored in flash 818. Baseband processor 812 controls a wireless wide area network (WWAN) transceiver 820 which is used for modulating and/or demodulating broadband network signals, for example for communicating via a Wi-Fi, LTE or WiMAX network or the like as discussed herein. The WWAN transceiver 820 couples to one or more power amps 822 respectively coupled to one or more antennas 824 for sending and receiving radio-frequency signals via the WWAN broadband network. The baseband processor 812 also may control a wireless local area network (WLAN) transceiver 826 coupled to one or more suitable antennas 828 and which may be capable of communicating via a Wi-Fi, Bluetooth, and/or an amplitude modulation (AM) or frequency modulation (FM) radio standard including an IEEE 802.11 a/b/g/n standard or the like. It should be noted that these are merely example implementations for applications processor 810 and baseband processor 812, and the scope of the claimed subject matter is not limited in these respects. For example, any one or more of SDRAM 814, NAND flash 816 and/or NOR flash 818 may comprise other types of memory technology such as magnetic memory, chalcogenide memory, phase change memory, or ovonic memory, and the scope of the claimed subject matter is not limited in this respect.

In one or more embodiments, applications processor 810 may drive a display 830 for displaying various information or data, and may further receive touch input from a user via a touch screen 832 for example via a finger or a stylus. An ambient light sensor 834 may be utilized to detect an amount of ambient light in which information handling system 800 is operating, for example to control a brightness or contrast value for display 830 as a function of the intensity of ambient light detected by ambient light sensor 834. One or more cameras 836 may be utilized to capture images that are processed by applications processor 810 and/or at least temporarily stored in NAND flash 816. Furthermore, applications processor may couple to a gyroscope 838, accelerometer 840, magnetometer 842, audio coder/decoder (CODEC) 844, and/or global positioning system (GPS) controller 846 coupled to an appropriate GPS antenna 848, for detection of various environmental properties including location, movement, and/or orientation of information handling system 800. Alternatively, controller 846 may comprise a Global Navigation Satellite System (GNSS) controller. Audio CODEC 844 may be coupled to one or more audio ports 850 to provide microphone input and speaker outputs either via internal devices and/or via external devices coupled to information handling system via the audio ports 850, for example via a headphone and microphone jack. In addition, applications processor 810 may couple to one or more input/output (I/O) transceivers 852 to couple to one or more I/O ports 854 such as a universal serial bus (USB) port, a high-definition multimedia interface (HDMI) port, a serial port, and so on. Furthermore, one or more of the I/O transceivers 852 may couple to one or more memory slots 856 for optional removable memory such as secure digital (SD) card or a subscriber identity module (SIM) card, although the scope of the claimed subject matter is not limited in these respects.

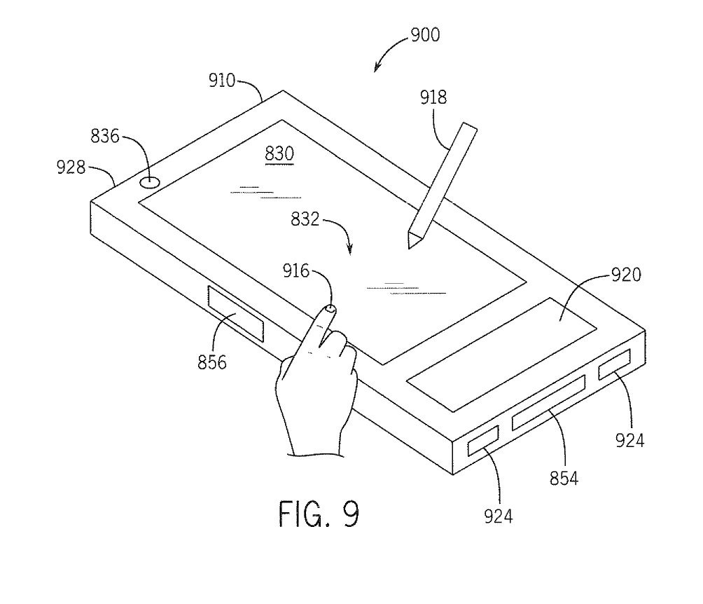

Referring now to FIG. 9, an isometric view of an information handling system 900 of FIG. 8 that optionally may include a touch screen in accordance with one or more embodiments will be discussed. FIG. 9 shows an example implementation of information handling system 800 of FIG. 8 tangibly embodied as a cellular telephone, smartphone, or tablet type device or the like. In one or more embodiments, the information handling system 800 may comprise platform 100 of FIG. 1, although the scope of the claimed subject matter is not limited in this respect. The information handling system 900 may comprise a housing 910 having a display 830 which may include a touch screen 832 for receiving tactile input control and commands via a finger or fingers 916 of a user and/or a via stylus 918 to control one or more applications processors 810. The housing 910 may house one or more components of information handling system 800, for example one or more applications processors 810, one or more of SDRAM 814, NAND flash 816, NOR flash 818, baseband processor 812, and/or WWAN transceiver 820. The information handling system 800 further may optionally include a physical actuator area 920 which may comprise a keyboard or buttons for controlling information handling system via one or more buttons or switches. The information handling system 900 may also include a memory port or slot 856 for receiving non-volatile memory such as flash memory, for example in the form of a secure digital (SD) card or a subscriber identity module (SIM) card. Optionally, the information handling system 800 may further include one or more speakers and/or microphones 924 and a connection port 854 for connecting the information handling system 900 to another electronic device, dock, display, battery charger, and so on. In addition, information handling system 800 may include a headphone or speaker jack 928 and one or more cameras 836 on one or more sides of the housing 910. It should be noted that the information handling system 800 of FIG. 9 may include more or fewer elements than shown, in various arrangements, and the scope of the claimed subject matter is not limited in this respect.

The following clauses and/or examples pertain to further embodiments:

One example embodiment may be a platform comprising a direct sequence spread spectrum receiver to receive a signal including a platform generated noise signal, a device to calculate a noise vector, and an adaptive filter to de-spread the noise vector and to subtract the scaled or filtered noise vector from the received signal. The platform may also include a noise signal generated from a bus, a memory circuit, a clock, a power supply, a circuit ground or integrated circuit substrate, or an input/output circuit of the platform. The platform may also include a device further configured to synchronize the calculated noise vectors with a symbol time of the receiver. The platform may also include a device further configured to implement two or more noise vector generation and processing blocks to arrive at a combined estimated error vector for two or more noise signals from two or more sources or paths. The platform may also include a front end coupled to a subtractor, coupled to a de-spread, coupled to a constellation de-mapper. The platform may also include an output of said de-mapper to feed error vectors to said filter. The platform may also include said filter to receive noise vectors and de-spread noise vectors. The platform may also include said filter to subtract scaled or filtered noise vectors from the received signal at the chip rate before de-spreading. The platform may also include said device to calculate noise vectors at a spreading or chip rate and de-spreading to a symbol rate. The platform may also include a multiplier and said noise vector being input to said multiplier, both with and without de-spreading. The platform may also include a touch screen display, keyboard, memory port, multiple antennas, a graphics processor, and speakers.

Another example embodiment may be a method comprising calculating noise vector based on bus noise, de-spreading the noise vector, and subtracting the scaled or filtered noise vector from a received direct sequence spread spectrum signal. The method may also include receiving a noise signal generated from a bus, a memory circuit, a clock, a power supply, a circuit ground or integrated circuit substrate, or an input/output circuit of a platform. The method may also include synchronizing the calculated noise vectors with a symbol time of a receiver. The method may also include implementing two or more noise vector generation and processing blocks to arrive at a combined estimated error vector for two or more noise signals from two or more sources or paths. The method may also include calculating noise vectors at a spreading or chip rate and de-spreading to a symbol rate. The method may also include multiplying noise vector both with and without de-spreading.

Another example embodiment may be one or more non-transitory computer readable media storing instructions to perform a sequence comprising receiving a direct spread spectrum signal including noise generated by a bus device, calculating a noise vector based on said noise, and filtering to remove the noise by de-spreading the noise vector and multiplying the de-spread noise vector by an error vector. The media may further store instructions to perform a sequence including receiving a noise signal generated from a bus, a memory circuit, a clock, a power supply, a circuit ground or integrated circuit substrate, or an input/output circuit of a platform. The media may further store instructions to perform a sequence including synchronizing the calculated noise vectors with a symbol time of a receiver. The media may further store instructions to perform a sequence including implementing two or more noise vector generation and processing blocks to arrive at a combined estimated error vector for two or more noise signals from two or more sources or paths. The media may further store instructions to perform a sequence including calculating noise vectors at a spread or chip rate and de-spreading to a symbol rate. The media may further store instructions to perform a sequence including multiplying noise vector both with and without de-spreading. The media may further store instructions to perform a sequence including providing an output of de-mapper to feed error vectors for said filtering. The media may further store instructions to perform a sequence including providing noise vectors without de-spreading and with de-spreading to said filtering.

Although the claimed subject matter has been described with a certain degree of particularity, it should be recognized that elements thereof may be altered by persons skilled in the art without departing from the spirit and/or scope of claimed subject matter. It is believed that the subject matter pertaining to baseband cancellation of platform radio interference and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1. A platform comprising:
a direct sequence spread spectrum receiver to receive a signal including a platform generated noise signal;
a device to calculate a noise vector at a chip rate;
a de-spreader to de-spread the noise vector;
an adaptive filter to receive the de-spread noise vector and use the de-spread noise vector to determine an error vector at the chip rate; and
a subtractor to subtract the error vector from the received signal at the chip rate.

2. A platform as claimed in claim 1, wherein the noise signal is generated from a bus, a memory circuit, a clock, a power supply, a circuit ground or integrated circuit substrate, or an input/output circuit of the platform.

3. A platform as claimed in claim 1, wherein the device is further configured to synchronize the calculated noise vectors with a symbol time of the receiver.

4. A platform as claimed in claim 1, wherein the device is further configured to implement two or more noise vector generation and processing blocks to arrive at a combined estimated error vector for two or more noise signals from two or more sources or paths.

5. A platform of claim 1 including a front end coupled to the subtractor, coupled to a de-spread, coupled to a constellation de-mapper.

6. A platform of claim 5 including an output of said de-mapper to feed error vectors to said filter.

7. A platform of claim 6, said filter to receive noise vectors and de-spread noise vectors.

8-9. (canceled)

10. A platform of claim 1 including a multiplier and said noise vector being input to said multiplier, both with and without de-spreading.

11. A platform of claim 1 including a touch screen display, keyboard, memory port, multiple antennas, a graphics processor, and speakers.

12. A method comprising:
calculating noise vector based on bus noise;
de-spreading the noise vector;
receiving the de-spread noise vector;
using the de-spread noise vector to determine an error vector at the chip rate; and
subtracting the error vector from the received signal at the chip rate.

13. A method as claimed in claim 12 including receiving a noise signal generated from a bus, a memory circuit, a clock, a power supply, a circuit ground or integrated circuit substrate, or an input/output circuit of a platform.

14. A method as claimed in claim 12 including synchronizing the calculated noise vectors with a symbol time of a receiver.

15. A method as claimed in claim 12 including implementing two or more noise vector generation and processing blocks to arrive at a combined estimated error vector for two or more noise signals from two or more sources or paths.

16. A method of claim 12 including calculating noise vectors at a spreading or chip rate and de-spreading to a symbol rate.

17. A method of claim 12 including multiplying noise vector both with and without de-spreading.

18. One or more non-transitory computer readable media storing instructions to perform a sequence comprising:
receiving a direct spread spectrum signal including noise generated by a bus device;
calculating a noise vector based on said noise;
de-spreading the noise vector;
using the de-spread noise vector to determine an error vector at the chip rate; and
subtracting the error vector from the received signal at the chip rate.

19. The media of claim 18 further storing instructions to perform a sequence including receiving a noise signal generated from a bus, a memory circuit, a clock, a power supply, a circuit ground or integrated circuit substrate, or an input/output circuit of a platform.

20. The media of claim 18 further storing instructions to perform a sequence including synchronizing the calculated noise vectors with a symbol time of a receiver.

21. The media of claim 18 further storing instructions to perform a sequence including implementing two or more noise vector generation and processing blocks to arrive at a combined estimated error vector for two or more noise signals from two or more sources or paths.

22. The media of claim 18 further storing instructions to perform a sequence including calculating noise vectors at a spread or chip rate and de-spreading to a symbol rate.

23. The media of claim 18 further storing instructions to perform a sequence including multiplying noise vector both with and without de-spreading.

24. The media of claim 18 further storing instructions to perform a sequence including providing an output of de-mapper to feed error vectors for said filtering.

25. The media of claim 18 further storing instructions to perform a sequence including providing noise vectors without de-spreading and with de-spreading to said filtering.
